(19) United States
(12) Patent Application Publication
(10) Pub. No.: US 2011/0210970 A1
(43) Pub. Date: Sep. 1, 2011

(54) DIGITAL MIRROR APPARATUS

(76) Inventor: Kazu Segawa, Osaka (JP)

(21) Appl. No.: 12/673,812

(22) PCT Filed: Jun. 16, 2009
(86) PCT No.: PCT/JP2009/002733

§ 371 Date: Feb. 17, 2010

(30) Foreign Application Priority Data
Jun. 18, 2008 (JP) 2008-158669

(51) Int. Cl. G06T 17/00

(52) U.S. Cl. 345/420

(57) ABSTRACT

A digital mirror apparatus that can reduce the uncomfortable feeling that the user who works while watching the displayed image feels in the horizontal direction and that can reduce the stress on the user. The digital mirror apparatus (100) for displaying an image of a user, which includes a posture identifying unit (102) which determines whether or not an image to be displayed is to be an image of a back of the user, and to generate posture information indicating a result of the determination, an image generating unit (103) which generates the image to be displayed by rendering three-dimensional model data of the user, and a display unit (104) which displays the image generated by the image generating unit (103), and the image generating unit (103) generates, as the image to be displayed, one of an image including a left-right reversed user image and an image including a left-right non-reversed user image, according to the posture information generated by the posture identifying unit (102).

### TECHNICAL FIELD

The present invention relates to a digital mirror apparatus for displaying an image of a user using three-dimensional model data showing the appearance of the shape of the user.

### BACKGROUND ART

There is a conventional digital mirror apparatus which displays a left-right reversed image based on an image of the user obtained by a visual sensor. (For example, see Patent Literature 1.) FIG. 14 shows a processing order of the conventional digital mirror apparatus disclosed in Patent Literature 1. FIG. 15 shows a display result of the conventional digital mirror apparatus disclosed in Patent Literature 1.

As shown in FIG. 14, the conventional digital mirror apparatus first obtains an image around the user from the visual sensor (step S901). Subsequently, the digital mirror apparatus creates a three-dimensional model from the obtained image (step S902). Then, the digital mirror apparatus generates left-right reversed image data from a three-dimensional model based on a set viewpoint (step S903). Finally, the digital mirror apparatus displays the generated image data (the front user image 1002 and the back user image 1003) on the display 1001 (step S904).

### CITATION LIST

### Patent Literature

[PTL 1] Japanese Patent No. 3505575

### SUMMARY OF INVENTION

### Technical Problem

However, with the conventional structure, the image data having the direction of back of the three-dimensional model as a view vector, with the viewpoint being behind the back of the three-dimensional model in step S903 is reversed in left and right, such as the back user image 1003 shown in FIG. 15. Accordingly, the movement of the back user image 1003 displayed on the digital mirror and the movement of the user 1004 himself/herself is reversed in the horizontal direction. As a result, the user who works while watching the image displayed by the digital mirror apparatus may find it difficult to work due to uncomfortable feeling that the user feels in the horizontal direction. Furthermore, with the conventional structure, when the user feels difficulty in working, an implicit instruction to display left-right non-reversed image is necessary.

The present invention has been conceived to solve the conventional problem, and it is an object of the present invention to provide a digital mirror apparatus which reduces the uncomfortable feeling that the user who works while watching the displayed image feels in the horizontal direction and reduce the stress on the user, when the user is working while watching the displayed image.

### Solution to Problem

In order to achieve the abovementioned object, an aspect of the digital mirror apparatus according to the present invention is a digital mirror apparatus for displaying an image of a user, the digital mirror apparatus including: a posture identifying unit which determines whether or not an image to be displayed is to be an image of a back of the user, and generates posture information indicating a result of the determination; an image generating unit which generates the image to be displayed by rendering three-dimensional model data of the user; and a display unit which displays the image generated by the image generating unit, in which the image generating unit generates, as the image to be displayed, one of an image including a left-right reversed user image and an image including a left-right non-reversed user image, according to the posture information generated by the posture identifying unit.

With this, it is possible to automatically generate the image including the left-right reversed user image or the image including the left-right non-reversed user image, depending on whether the image to be displayed is to be the image of the back of the user or not. Accordingly, it is possible to reduce the uncomfortable feeling that the user who works while watching the displayed image feels in the horizontal direction, and reduce the stress on the user.

Furthermore, it is preferable that the image generating unit generates the image including the left-right non-reversed user image when the posture information generated by the posture identifying unit indicates that the image to be displayed is to be the image of the back of the user, and generates the image including the left-right reversed user image when the posture information generated by the posture identifying unit indicates that the image to be displayed is not to be the image of the back of the user.

With this, when the image to be displayed is an image of the back of the user, it is possible to automatically generate the image including the left-right non-reversed user image. Accordingly, it is possible to reduce the uncomfortable feeling that the user who works while watching the displayed image feels in the horizontal direction, and reduce the stress on the user.

Still further, it is preferable to include a model data storage unit in which the three-dimensional model data of the user is stored, in which the image generating unit is configured to render the three-dimensional model data stored in the model data storage unit.

With this, the image generated from the stored three-dimensional model data of the user can be displayed, which allows display of the user image based on the present or past three-dimensional model data that the user wishes to see.

Furthermore, it is preferable that the posture identifying unit determines that the image to be displayed is to be the image of the back of the user when a viewpoint from which to render the three-dimensional model data is positioned in a back side of the three-dimensional model data.

With this, it is possible to determine whether or not the image to be displayed is to be the image of the back of the user, using the position of the viewpoint when rendering the three-dimensional model data. Accordingly, even when the plural images are generated from the positions of different viewpoints, it is possible to appropriately determine whether or not the image is reversed in left and right. Thus, it is possible to reduce the uncomfortable feeling that the user who works while watching the displayed image feels in the horizontal direction.

Furthermore, it is preferable that the posture identifying unit identifies the back side of the three-dimensional model data based on an angle around an axis which is substantially perpendicular to a floor, and determines that the image to be displayed is the image of the back of the user when the viewpoint is located on the back side of the three dimensional model data.

With this, it is possible to increase the precision of the determination on whether or not the image to be displayed is to be the image of the back of the user. Thus, it is possible to further reduce the uncomfortable feeling that the user who works while watching the displayed image feels in the horizontal direction.

Furthermore, it is preferable to include a camera which captures an image the user from a plurality of directions; and a model data generating unit configured to generate three-dimensional model data of the user from the image captured by the camera, in which the image generating unit is configured to render the three-dimensional model data generated by the model data generating unit.

This allows the display of user image viewed from plural viewpoints, which cannot be displayed by the conventional mirror.

Furthermore, it is preferable that the posture identifying unit obtains sensor information indicating the posture of the user generated by a posture sensor, to identify a position and a direction of the user with respect to a display surface in the display unit using the obtained sensor information, and to determine whether or not the image to be displayed is the image of the back of the user.

With this, it is possible to determine whether or not the image to be displayed is to be the image of the back of the user, according to the current posture of the user. Thus, even when the direction of the user image to be displayed changes according to the current posture of the user, it is possible to switch between the reversed in left and right and non-reversed. Accordingly, it is possible to reduce the uncomfortable feeling that the user who works while watching the displayed image feels in the horizontal direction.

Furthermore, it is preferable that the posture identifying unit determines whether or not the image to be displayed is to be the image of the back of the user, based on the image captured by the camera.

With this, it is possible to generate posture information based on an image to generate a three-dimensional image. Thus, it is possible to reduce the uncomfortable feeling that the user who works while watching the displayed image feels in the horizontal direction with a relatively simple structure.

Furthermore, it is preferable that the posture identifying unit determines the image to be displayed is to be the image of the back of the user, when a facial image cannot be extracted from the image captured by the camera.

With this, it is possible to generate the posture information based on whether or not the facial image can be extracted or not. Thus, it is possible to improve the precision of the determination on whether or not the image to be displayed is to be an image of the back of the user.

Furthermore, an aspect of an integrated circuit according to the present invention is an integrated circuit for generating an image of a user, which is an image to be displayed on a display unit, the integrated circuit including: a posture identifying unit which determines whether or not the image to be displayed is to be an image of a back of the user and to generate posture information indicating a result of the determination; an image generating unit which generates the image to be displayed by rendering three-dimensional model data of the user; and in which the image generating unit generates, as the image to be displayed, one of an image including a left-right reversed user image and an image including a left-right non-reversed user image, according to the posture information generated by the posture identifying unit.

Furthermore, an image display method for displaying an image of a user, the method including: determining whether or not an image to be displayed is to be an image of a back of the user to generate posture information indicating a result of the determination; generating the image to be displayed by rendering three-dimensional model data of the user; and displaying the image generated in the generating, in which in the generation of the image, one of an image including a left-right reversed user image and an image including a left-right non-reversed user image is generated as the image to be displayed, according to the posture information generated in the identifying.

Note that, the present invention may not only be implemented as the image display method, but also as a program causing a computer to execute the steps included in the image display method. Furthermore, the program may be distributed via recording media such as CD-ROM and transmission media such as the Internet.

### ADVANTAGEOUS EFFECTS OF INVENTION

According to an aspect of the digital mirror apparatus of the present invention, an image including a left-right reversed image of the user or an image including a left-right non-reversed image of the user can be displayed depending on whether or not the image to be displayed is to be an image of the back of the user. Accordingly, it is possible to reduce the uncomfortable feeling that the user who works while watching the displayed image feels in the horizontal direction.

(Further Information about Technical Background to this Application)

The disclosure of Japanese Patent Application No. 2008-158669 filed on Jun. 18, 2008 including specification, drawings and claims is incorporated herein by reference in its entirety.

### BRIEF DESCRIPTION OF DRAWINGS

FIG. 1 is a block diagram showing a functional structure of the digital mirror apparatus according to Embodiment 1 of the present invention.

FIG. 2 is an explanatory diagram of the coordinate axes of model data according to Embodiment 1 of the present invention.

FIG. 3 is a diagram showing a use of the digital mirror apparatus according to Embodiment 1 of the present invention.

FIG. 4 is a flowchart showing a process flow of the digital mirror apparatus according to Embodiment 1 of the present invention.

FIG. 5 is a diagram showing a use of the digital mirror apparatus according to a variation of Embodiment 1 of the present invention.

FIG. 6 is a block diagram showing a functional structure of the digital mirror apparatus according to Embodiment 2 of the present invention.

FIG. 7 is a diagram showing a use of the digital mirror apparatus according to Embodiment 2 of the present invention.

FIG. 8 is a flowchart showing a process flow of the digital mirror apparatus according to Embodiment 2 of the present invention.

FIG. 9 is a block diagram showing a functional structure of the digital mirror apparatus according to Embodiment 3 of the present invention.

FIG. 10 is a diagram showing a use of the digital mirror apparatus according to Embodiment 3 of the present invention.

FIG. 11 is a flowchart showing a process flow in the digital mirror apparatus according to Embodiment 3 of the present invention.

FIG. 12 is a block diagram showing a functional structure of the digital mirror apparatus according to Embodiment 4 of the present invention.

FIG. 13 is a flowchart showing a process flow in the digital mirror apparatus according to Embodiment 4 of the present invention.

FIG. 14 is a flowchart showing the process order of the conventional digital mirror apparatus.

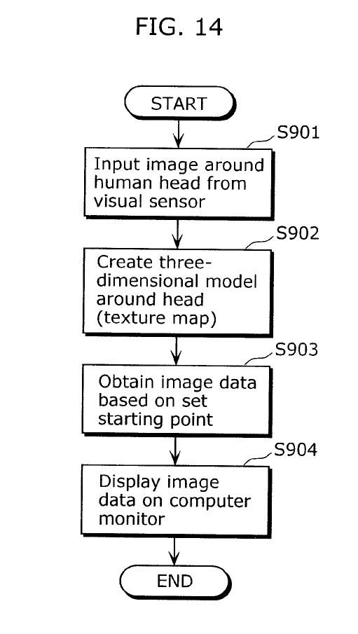

FIG. 15 is a diagram showing the display result of the conventional digital mirror apparatus.

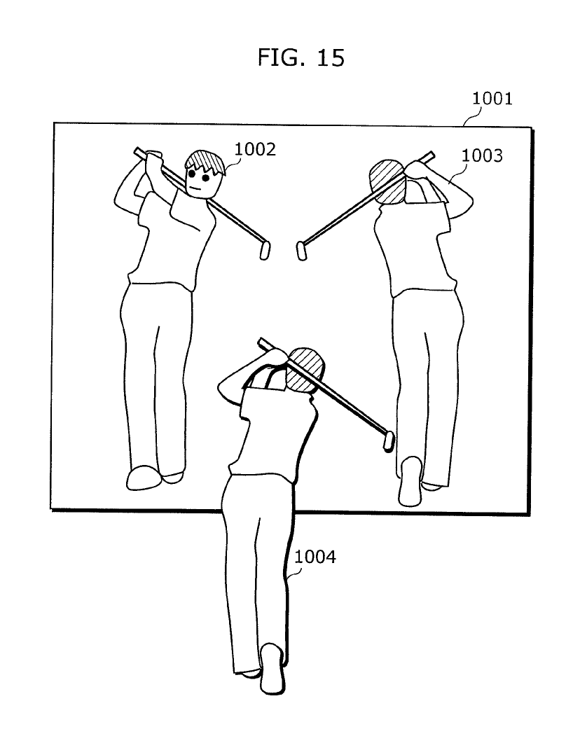

### DESCRIPTION OF EMBODIMENTS

The embodiments of the present invention will be described as follows with reference to the drawings.

### Embodiment 1

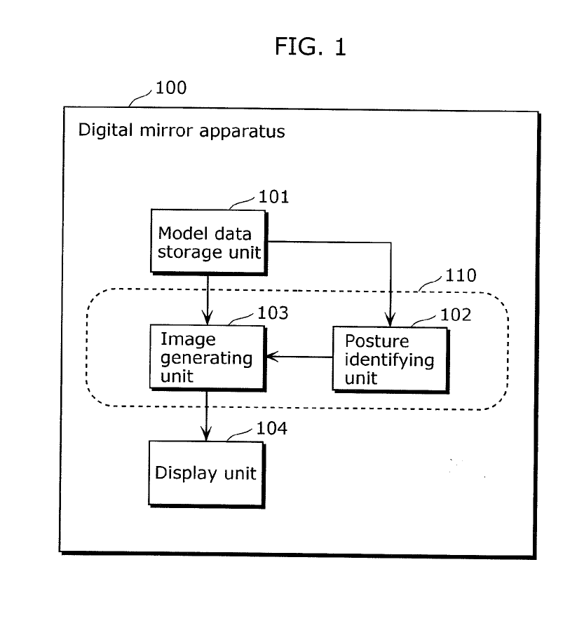

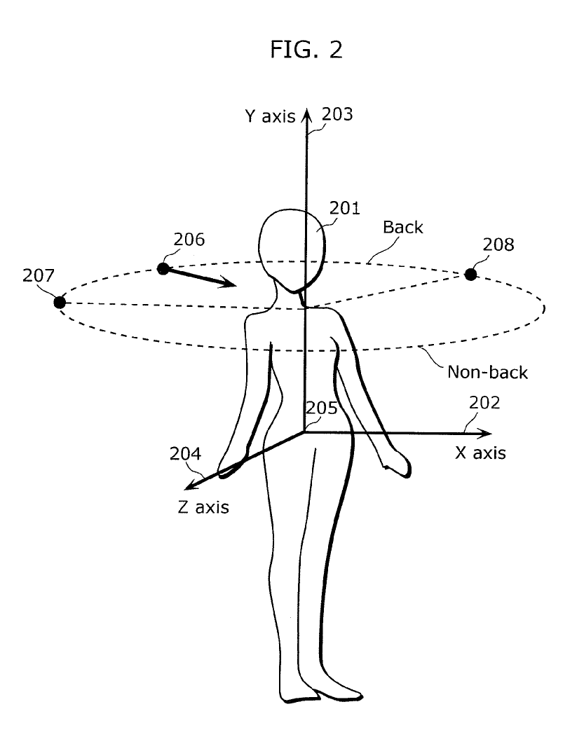

FIG. 1 is a block diagram showing the functional structure of the digital mirror apparatus according to Embodiment 1 of the present invention. FIG. 2 is an explanatory diagram of the coordinate axes of the model data according to Embodiment 1 of the present invention. As shown in FIG. 1, a digital mirror apparatus 100 includes a model data storage unit 101, a posture identifying unit 102, an image generating unit 103, and a display unit 104.

The model data storage unit 101 is composed of a recording medium such as a non-volatile memory or a volatile memory, for example, and stores three-dimensional model data of the user. More specifically, the model data storage unit 101 stores, as a human body model data, the coordinates of the three-dimensional model data obtained by measuring the body of the user, texture data, data regarding light source, the viewpoint, the view vector, and a coordinate transformation matrix in the frame. The three-dimensional human body model data and the viewpoint are defined in a coordinate system where a Y axis 203 is perpendicular to the floor face passes through the center of the human body model, and an XZ plane is parallel to the floor face, as shown in FIG. 2.

As shown in FIG. 2, the coordinate system of the three-dimensional model data 201 is defined as follows: the center of the body is the originating point 205, an axis extending to a direction of the head and perpendicular to the floor is an Y axis 203, and the axes horizontal to the floor are an X axis 202 and a Z axis 204.

The posture identifying unit 102 determines whether or not the image to be displayed on the display unit 104 is an image of the back of the user, and generates posture information indicating the determination result. More specifically, when the viewpoint 206 upon rendering the three-dimensional model data 201 is positioned in the back side of the three-dimensional model data 201, the posture identifying unit 102 determines that the image to be displayed is an image of the back of the user. Note that, from now on, the case where the image to be displayed on the display unit 104 is an image of the back of the user is also referred to as having a “back” posture. Similarly, the case where an image to be displayed on the display unit 104 is not an image of a back of the user is referred to as having “non-back” posture as well.

Furthermore, the posture identifying unit 102 reads the coordinates of the viewpoint 206 from the model data storage unit 101. Subsequently, the posture identifying unit 102 determines that the posture is “back” when the viewpoint 206 is within a range from a rotation angle 207 to the rotation angle 208 clockwise around the Y axis when viewed from the positive direction of the Y axis, and determines that the posture is “non-back” in other cases.

Note that, as shown in FIG. 2, it is preferable to have the range from the rotation angle 207 to the rotation angle 208 clockwise around the Y axis when viewed from the positive direction of the Y axis smaller than 180 degrees. In other words, it is preferable to have the range of angles indicating “back” smaller than the range of angles indicating “non-back”. With this, the digital mirror apparatus 100 can generate an image including the left-right reversed user image when the image to be displayed is an image of the side of the user, further reducing the uncomfortable feeling that the user who works while watching the displayed image feels in the horizontal direction.

The image generating unit 103 generates the image to be displayed on the display unit 104 by rendering the three-dimensional model data 201 stored in the model data storage unit 101. Note that, the image generating unit 103 generates either the image including the left-right reversed user image or the image including the left-right non-reversed user image on the display unit 104, according to the posture information generated by the posture identifying unit 102. More specifically, when the posture information generated by the posture identifying unit 102 indicates “back”, the image generating unit 103 generates an image including a left-right non-reversed user image as an image to be displayed on the display unit 104. On the other hand, when the posture information generated by the posture identifying unit 102 indicates “non-back”, the image generating unit 103 generates an image including left-right reversed user image as an image to be displayed on the display unit 104.

Furthermore, more specifically, the image generating unit 103 performs a series of rendering such as modeling transformation, lighting calculation, projective transformation, viewport transformation, texture mapping and others, using the human body model data read from the model data storage unit 101. Here, when the posture information obtained from the posture identifying unit 102 indicates “back”, the image generating unit 103 performs a viewport transformation which does not reverse the sign of X (Equations 1). On the other hand, when the posture information obtained from the posture identifying unit 102 indicates “non-back”, the image generating unit 103 performs left-right reversed viewport transformation in which the sign of X is reversed (Equations 2). With this rendering, the image generating unit 103 generates a two-dimensional image (an image including a left-right reversed user image or an image including a left-right non-reversed user image) to be displayed on the display unit 104 from the three-dimensional model data 201.

$$\begin{matrix}[ Math . 1 ] & \\ xw = \frac{( xd + 1 ) W}{2} + x \\ Λ \\ yw = \frac{( y d + 1 ) H}{2} + y & ( Equations 1 ) \\ [ Math . 2 ] & \\ xw = \frac{( - xd + 1 ) W}{2} + x \\ Λ \\ yw = \frac{( y d + 1 ) H}{2} + y & ( Equation 2 )\end{matrix}$$

In Equations 1 and 2, (xw, yw) denotes display coordinates, (xd, yd) denotes normalized device coordinates, (x, y) denotes offset coordinates of the viewport, W denotes horizontal direction pixel size, and H denotes vertical direction pixel size.

Note that, the image generating unit 103 can generate plural images each of which differs, for example, in a position of the model, angle, size, and the position of the viewpoint, from one three-dimensional model by changing the parameter used for rendering. For example, the image generating unit 103 can generate an image with narrowed horizontal width (for example, in the X axis direction) of the three-dimensional model (skinny user image) and an image with widened horizontal width of the three-dimensional model (fat user image), from one three-dimensional model. Furthermore, for example, the image generating unit 103 can generate images when the three-dimensional model viewed from a predetermined position of the three-dimensional model, such as front, back, top, and bottom, using one three-dimensional model. Furthermore, for example, the image generating unit 103 can generate an animated image in which the three-dimensional model rotates a round from one three-dimensional model, by causing the three-dimensional model to rotate about the Y axis in a time series.

The display unit 104 outputs the image generated by the image generating unit 103 to a display and others.

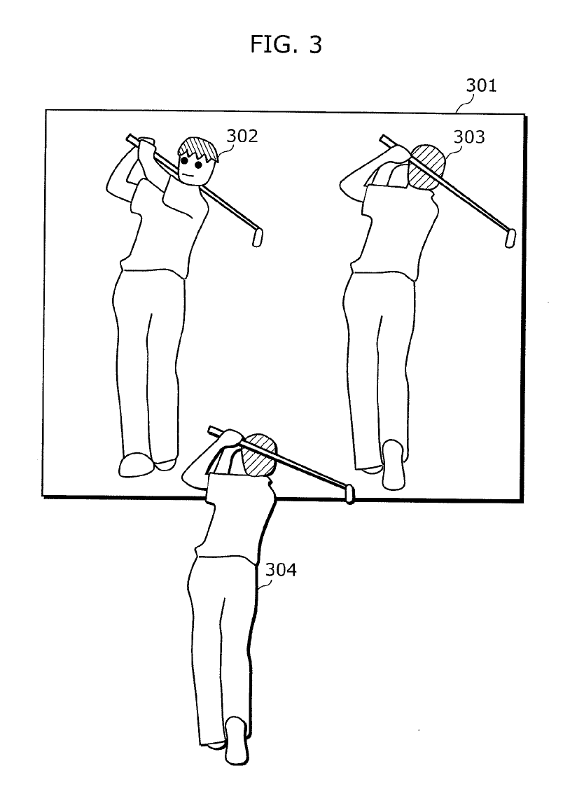

FIG. 3 shows a use of the digital mirror apparatus according to the Embodiment 1 of the present invention. The display unit 104 corresponds to the display 301. The front user image 302 showing the human body model reproducing the ideal golf swinging form and the back user image 303 are simultaneously displayed on the display 301.

Next, the operations in the digital mirror apparatus 100 composed as shown above are described.

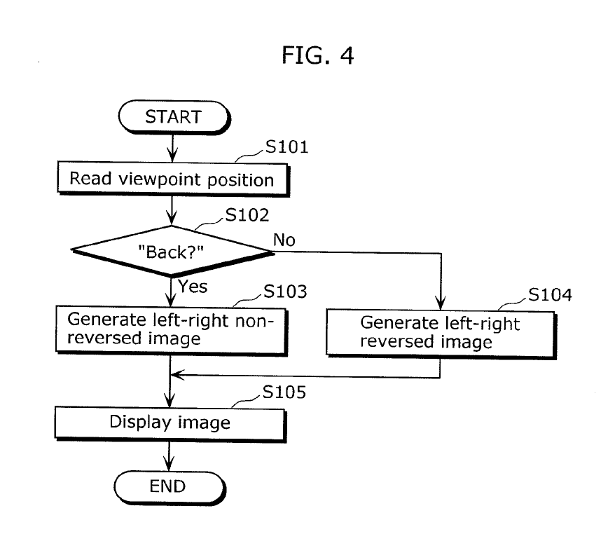

FIG. 4 is a flowchart showing the process flow by the digital mirror apparatus according to Embodiment 1 of the present invention.

First, the posture identifying unit 102 reads the coordinates indicating the position of the viewpoint 206 from the model data storage unit 101 (step S101). Subsequently, the posture identifying unit 102 determines “back” or “non-back” by determining whether the coordinates indicating the position of the viewpoint 206 are within a range from the rotation angle 207 to the rotation angle 208 clockwise around the Y axis when viewed from the positive direction of the Y axis (step S102). More specifically, when the coordinates indicating the position of the viewpoint 206 are within the range from the rotation angle 207 to the rotation angle 208 clockwise around the Y axis when viewed from the positive direction of the Y axis, the posture identifying unit 102 determines as “back”. On the other hand, when the coordinates indicating the position of the viewpoint 206 are not within the range from the rotation angle 207 to the rotation angle 208 clockwise around the Y axis when viewed from the positive direction of the Y axis, the posture identifying unit 102 determines as “non-back”.

Here, when it is determined as “back” (Yes in step S102), the image generating unit 103 generates an image including the left-right non-reversed user image from the three-dimensional model data by performing viewport transformation using (Equations 1) in rendering (step S103). On the other hand, when it is determined as “non-back” (No in step S102), the image generating unit 103 generates an image including the left-right reversed user image from the three-dimensional model data by performing viewport transformation using (Equations 2) in rendering (step S104).

Finally, the display unit 104 displays the image generated in step S103 or step S104 (step S105).

As described above, the digital mirror apparatus 100 can dynamically switch the image including the left-right reversed user image and the image including the left-right non-reversed user image, according to the posture of the three-dimensional model data and without the operation by the user. With this, regardless of the direction of the user image included in the image displayed on the display unit 104, the user can work comparing the image with the his/her own movement without uncomfortable feeling. Furthermore, the digital mirror apparatus 100 can reduce the stress on the user, since it is not necessary for the user to instruct the switch between reversing left and right, and not reversing left and right of the user image.

Note that, although the posture identifying unit according to Embodiment 1 uses the rotation angle around the Y axis, the rotation angles around the X axis or the Z axis may also be used.

Furthermore, the digital mirror apparatus according to Embodiment 1 may also include a mirror arranged substantially parallel to the display surface included in the display unit 104. More specifically, the digital mirror apparatus may include a half mirror in the anterior half of the display surface of the display unit 104. In this case, the image displayed by the display unit 104 transmits the half mirror. Thus, the user can visually recognize the image displayed by the display unit 104 and the mirror image reflected on the half mirror.

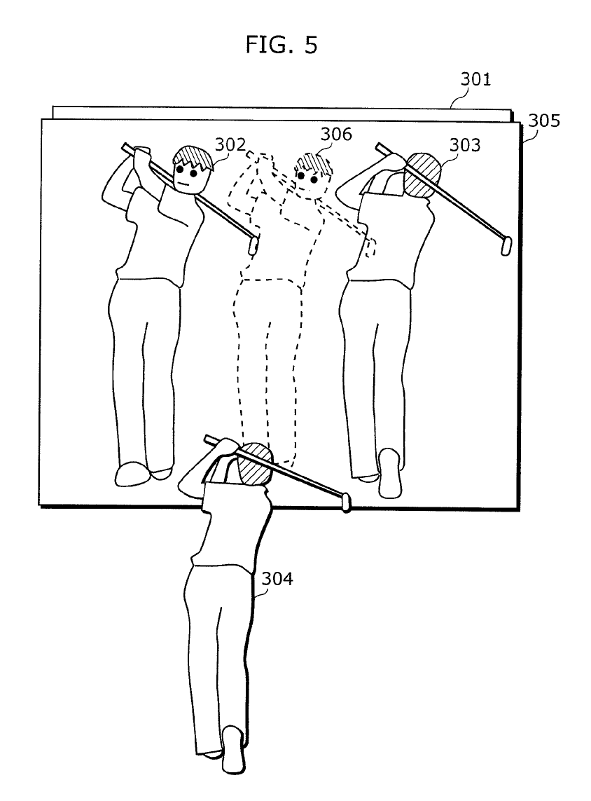

FIG. 5 shows a use of the digital mirror apparatus according to a variation of Embodiment 1 of the present invention. As shown in FIG. 5, in addition to a user image 302 of the front side of the three-dimensional model data and a user image 303 of the back of the three-dimensional model data, and the mirror image 306 which is an image of the user reflected on the mirror are also displayed on the half mirror 305. This allows the user 304 to easily recognize the difference between the user image displayed by the display unit 104 and the own mirror image 306 reflected on the half mirror. That is, the digital mirror apparatus can improve the convenience of the user.

Note that, the digital mirror apparatus may include a regular mirror posterior to the display device that becomes completely transparent when the luminance is 0, instead of including a half mirror anterior to the display surface of the display unit 104. With this, the digital mirror apparatus can produce the same effect to the case where the half mirror is provided in the anterior half of the display surface.

Furthermore, although the ideal form data is used as the three-dimensional model data in this embodiment, previous form of the user may also be used as the three-dimensional model data.

### Embodiment 2

Next, Embodiment 2 of the present invention will be described with reference to the drawings.

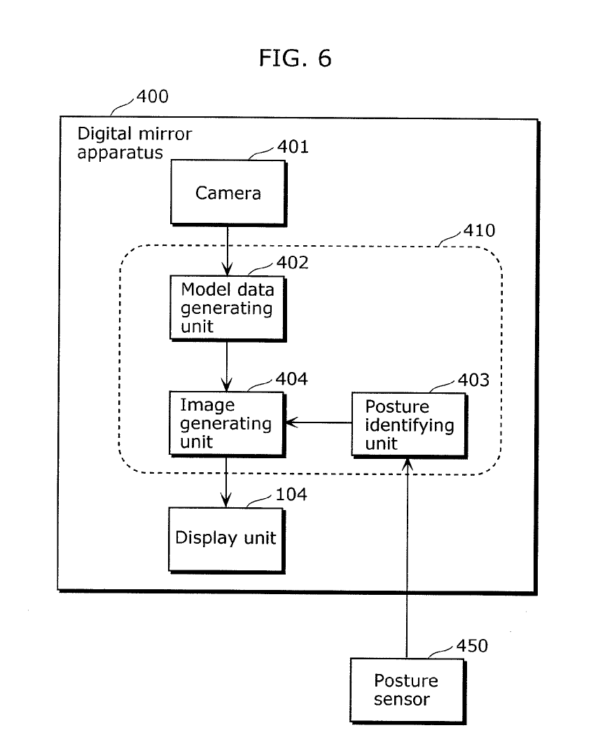

FIG. 6 is a block diagram showing the functional structure of the digital mirror apparatus according to Embodiment 2 of the present invention. As shown in FIG. 6, the digital mirror apparatus 400 according to Embodiment 2 does not include the model data storage unit 101 included in the digital mirror apparatus 100 according to Embodiment 1. Furthermore, the digital mirror apparatus 400 according to Embodiment 2 includes cameras 401 and a model data generating unit 402. Furthermore, a part of processing in the posture identifying unit 403 and the image generating unit 404 differ from those of the posture identifying unit 102 and the image generating unit 103 according to Embodiment 1. Note that, in FIG. 6, the same reference signs are used for the components identical to those in FIG. 1, and the description for these components is omitted.

The camera 401 almost simultaneously captures the user from plural directions. The model data generating unit 402 generates three-dimensional human body model data (three-dimensional model data) and texture data using the Phase Only Correlation, from captured plural images.

The posture sensor 450 generates sensor information indicating the posture of the user. More specifically, the posture sensor 450 is a positional sensor or an angle sensor such as a gyroscope or a tracker attached to the user and generates data indicating the position and angle of the user as sensor information.

The posture identifying unit 403 obtains the sensor information indicating the posture of the user from the posture sensor 450, and calculates the standing position and the angle of the user with respect to the display surface of the display unit 104. Subsequently, the posture determining unit 403 determines the current posture of the user as “back” or “non-back” from the calculated position and angle.

The image generating unit 404 renders the three-dimensional model data generated by the model data generating unit 402. Note that, the image generating unit 404 in Embodiment 2 and the image generating unit 103 in Embodiment 1 render different three-dimensional model data. However, other processes are identical.

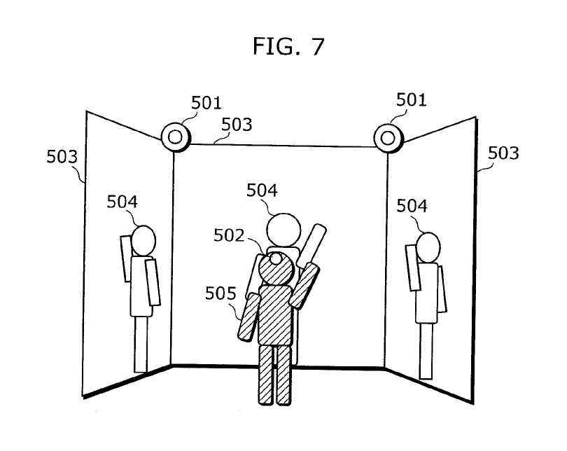

FIG. 7 shows a use of the digital mirror apparatus according to Embodiment 2 of the present invention. As shown in FIG. 7, plural cameras 501 capture the user 505 from plural directions. The posture sensor 502 worn by the user 505 (for example, on his/her head) senses the posture of the user. Furthermore, each of plural displays 503 which is provided at different angles to the user displays the user image 504 according to the posture of the user with respect to each display surface. Note that, although only two cameras are shown as the cameras 501 in FIG. 7, the digital mirror apparatus 400 may include more cameras.

Next, the operations in the digital mirror apparatus 400 configured as shown above are described.

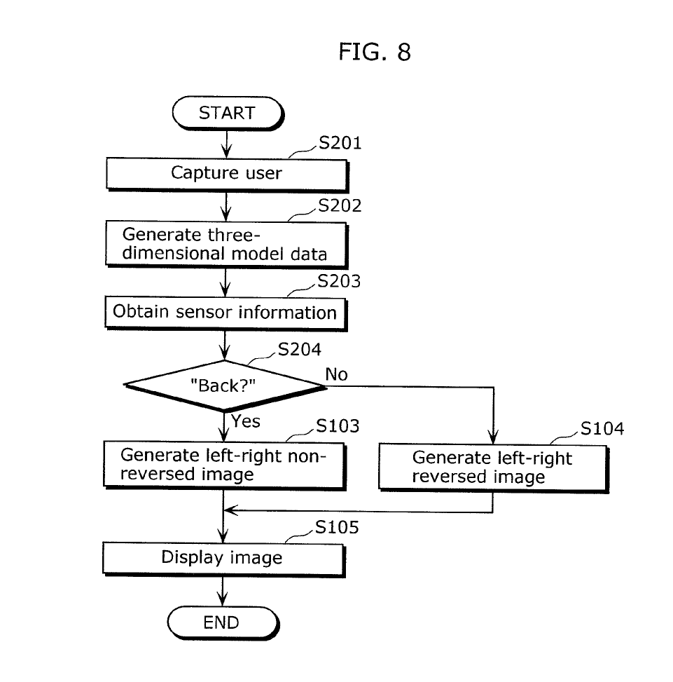

FIG. 8 is a flowchart showing the process flow of the digital mirror apparatus according to Embodiment 2 of the present invention. Note that, in FIG. 8, the same reference signs are assigned to the processes identical to those in FIG. 4, and the detailed description for those processes is omitted.

First, the cameras 401 simultaneously capture the user from plural directions (step S201). Subsequently, the model data generating unit 402 generates the three-dimensional model data and the three-dimensional texture data from the plural captured images using the Phase Only Correlation (step S202). Subsequently, the posture identifying unit 403 obtains the sensor information indicating the position and angle of the user from the posture sensor 450 (step S203).

Next, the posture identifying unit 403 calculates the position and angle of the user with respect to the display surface of the display unit 104. Subsequently, the posture determining unit 403 determines the current posture of the user as “back” or “non-back” from the calculated position or angle (step S204).

Subsequently, the digital mirror apparatus 400 performs the processes identical to the processes described in FIG. 4 (step S103 or step S104, and step S105).

As described above, the digital mirror apparatus 400 can dynamically switch between the image including the left-right reversed image of the user and the image including left-right non-reversed image of the user, according to the current user's posture with respect to the display surface and without the operation by the user him/herself. With this, even when the user image to be displayed on the display surface is changed due to the change in the user's posture, the user can work while comparing the displayed user image and his/her own movement without uncomfortable feeling.

Note that, the posture sensor 450 is the positional sensor or the angle sensor worn by the user, in Embodiment 2. However, the posture sensor 450 may be a motion capture system and others.

Furthermore, the posture sensor 450 may be a sheet sensor provided on the floor in front of the display surface. In this case, the posture sensor 450 generates the sensor information which indicates the position and pressure where the user contacts the sensor. Furthermore, the posture identifying unit 403 calculates the position and the angle of the user with respect to the display surface by identifying the position of the gravity center from the sensor information which indicates the position and pressure in which the user contacts the sensor, for example.

Furthermore, the posture sensor 450 may be a thermography provided at a position having a predetermined positional relationship with the display unit 104 or the user. In this case, the posture sensor 450 generates the image indicating the thermal distribution of the user as the sensor information. Subsequently, the posture identifying unit 403 calculates the position and angle of the user with respect to the display surface from the thermal distribution of the user. Note that, the position to have a predetermined positional relationship with the display unit 104 or the user refers to a position apart from a predetermined distance from a predetermined direction with the display surface included in the display unit 104 or from the user. More specifically, the posture identifying unit 403 may obtain a display surface included in the display unit 104 or a direction or distance from the user.

Furthermore, the posture sensor 450 may be an infrared sensor provided around the display unit 104 or the user. In this case, the posture sensor 450 generates an image indicating a distribution of the depth of the user as the sensor information by measuring the distance from the posture sensor 450 to the user. Furthermore, the posture identifying unit 403 calculates the position and the angle of user with respect to the display surface by searching the images that have been stored according to the position and the angle of the user with respect to the display surface, for an image similar to the image indicating the distribution of the depth of the user obtained from the posture sensor 450.

Furthermore, the model data generating unit 402 according to Embodiment 2 generates the three-dimensional model data using the Phase Only Correlation. However, the three-dimensional model data may be generated using the three-dimensional measuring method using stereo cameras such as the stereo correlation.

Furthermore, the digital mirror apparatus 400 may include the posture sensor 450.

### Embodiment 3

Next, Embodiment 3 of the present invention will be described with reference to the drawings.

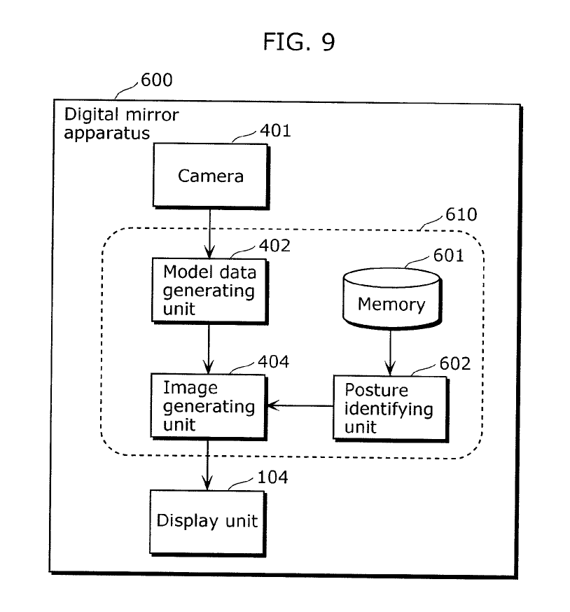

FIG. 9 is a block diagram showing the functional structure of the digital mirror apparatus according to Embodiment 3 of the present invention. As shown in FIG. 9, the digital mirror apparatus 600 according to Embodiment 3 includes a memory 601, in addition to the components included in the digital mirror apparatus 400 according to Embodiment 2. Furthermore, a part of the processes performed by the posture identifying unit 602 according to Embodiment 3 differs from those performed by the posture identifying unit 403 according to Embodiment 2. Note that, in FIG. 9, the same reference signs are used for the components identical to those in FIG. 1 and FIG. 6, and the description for these components is omitted.

The posture identifying unit 602 refers to the basic data of the human body model registered on the memory 601 in advance, and determines the coordinate axis and viewpoint of the three-dimensional model data by matching the three-dimensional model data generated by the model data generating unit 402. Furthermore, the posture identifying unit 602 determines that the user's posture as “back” when the viewpoint is within the range determined by a rotation angle around the Y axis, and determines that the posture of the user as “non-back” in other cases in the same manner as the process in Embodiment 1.

Note that, the camera 401, the model data generating unit 402, the image generating unit 404 and the display unit 104 perform the processes identical to those in Embodiment 2.

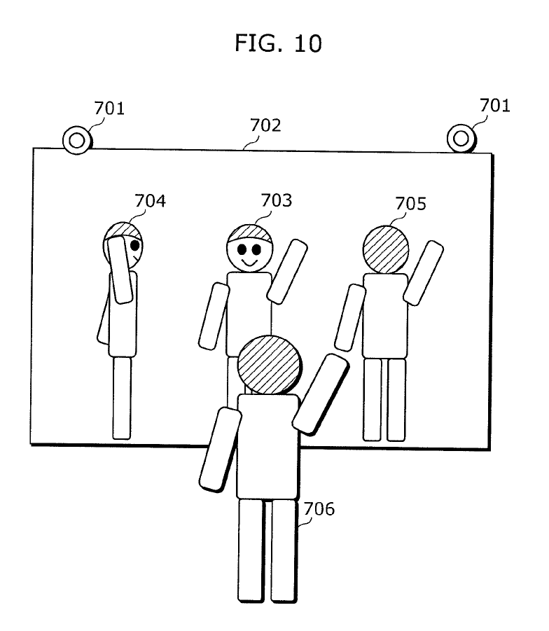

FIG. 10 shows the use of the digital mirror apparatus in Embodiment 3 of the present invention. As shown in FIG. 10, the cameras 701 capture the user 706 from plural directions. Based on the three-dimensional model data corresponding to the current posture of the user 706, the generated user images 703, 704, and 705 from plural viewpoints are simultaneously displayed on the display 702.

Next, the operations in the digital mirror apparatus 600 composed as shown above are described.

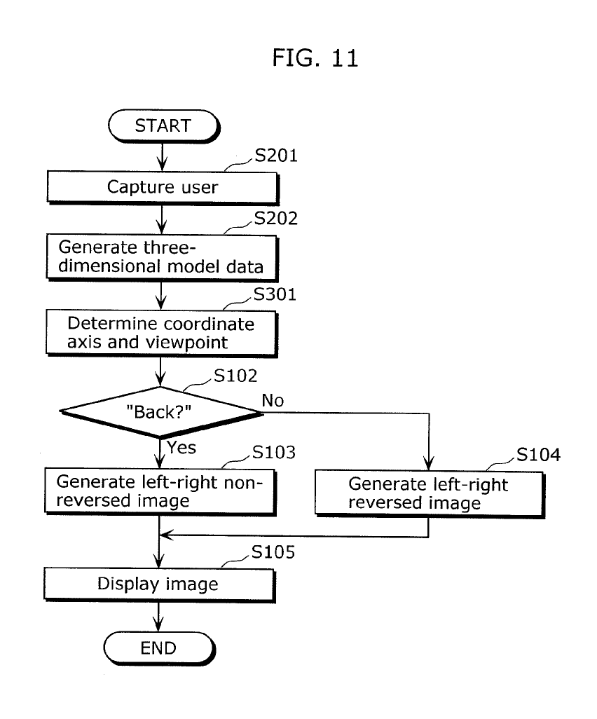

FIG. 11 is a flowchart showing the process flow performed by the digital mirror apparatus according to Embodiment 3 of the present invention. Note that, in FIG. 11, the same reference signs are assigned to the processes identical to those in FIG. 4 and FIG. 8, and the detailed description for those processes is omitted.

First, in the same manner as FIG. 8, the digital mirror apparatus 600 performs the process in step S201 and step S202.

Subsequently, the posture identifying unit 602 reads the basic data of the human body model registered in the memory 601 in advance. Then the posture identifying unit 602 determines the coordinate axis and viewpoint of the three-dimensional model data by matching the read basic data and the three-dimensional model data generated in step S202 (step S301).

Subsequently, the digital mirror apparatus 600 performs the process identical to the process described in FIG. 4 (step S102, and step S103 or step S104, and step S105).

As described above, the digital mirror apparatus 600 can display the current user image from plural viewpoints that cannot be seen by using a conventional mirror. Subsequently, when displaying the current user image, the digital mirror apparatus 600 can dynamically switch between the left-right reversed user image and the left-right non-reversed user image according to the current posture of the user and without the operation by the user himself/herself. With this, the user can work while comparing any image displayed on the display unit 104 with his/her movement without uncomfortable feeling.

Note that, in Embodiment 3, the posture identifying unit 602 determines the coordinate axis using the basic data of the human body model held in the memory in advance. However, the coordinate axis may also be determined using, for example, a boundary box of the human body model data generated by the model data generating unit 402.

Furthermore, in addition to the basic data of the human body data, the posture data may also be stored in the memory. In this case, the posture identifying unit may determine “back” or “non-back” only by matching, without using the coordinate axis.

Furthermore, the image generating unit may generate an image such that when the left-right reversed image and the non-reversed image are switched, the switching occurs naturally using an animation effect instead of sudden switching.

### Embodiment 4

Next, Embodiment 4 of the present invention will be described with reference to the drawings.

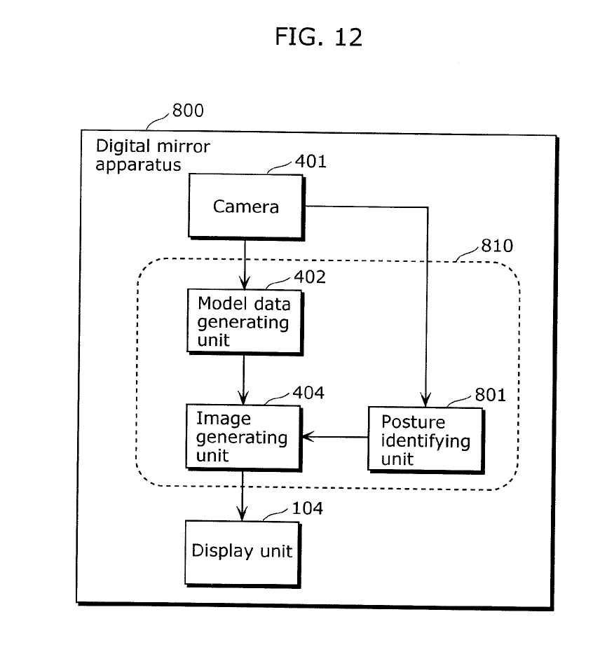

FIG. 12 is a block diagram showing the functional structure of the digital mirror apparatus according to Embodiment 4 of the present invention. A posture identifying unit 801 included in the digital mirror apparatus 800 according to Embodiment 4 is different from the posture identifying unit 403 according to Embodiment 2 in that “back” and “non-back” are determined based on an image captured by the camera 401. Note that in FIG. 12, the same reference signs are assigned to the components identical to those in FIGS. 1, 6, and 9, and the description for those components is omitted.

The posture identifying unit 801 extracts a facial image from the image of the user captured by the cameral 401 using the facial features such as eyes, nose, mouth, eyebrows and others. Here, when the facial image is successfully extracted, the posture determining unit 801 determines the posture of the user as “non-back”. On the other hand, when extraction of the facial image fails, the posture identifying unit 801 determines the posture of the user as “back”.

Note that, the model data generating unit 402, the image generating unit 103 and the display unit 104 perform the processes same as those in Embodiment 2.

Next, the operations in the digital mirror apparatus 800 composed as shown above are described.

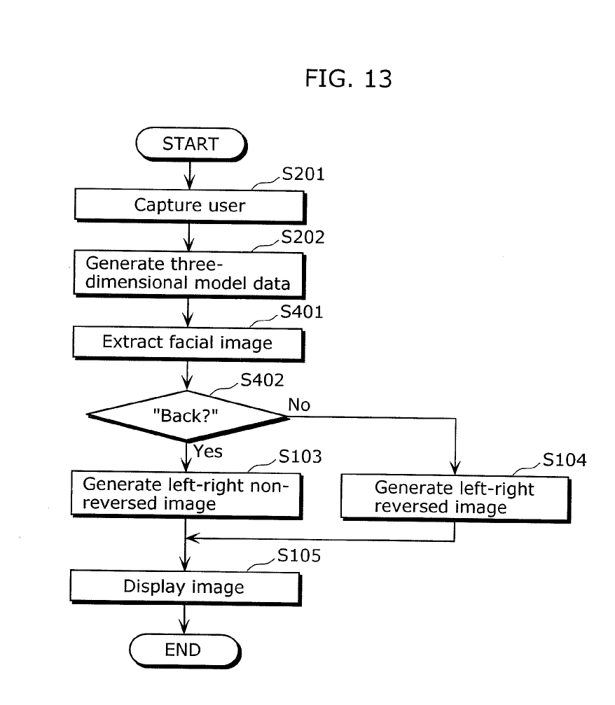

FIG. 13 is a flowchart showing the flow by the digital mirror apparatus according to Embodiment 4. Note that, in FIG. 13, the same reference signs are assigned to the processes identical to those shown in FIG. 4, 8, or 11, and the description for those processes is omitted.

First, in the same manner as FIG. 8, the digital mirror apparatus 800 performs the processes in step S201 and step S202.

Subsequently, the posture determining unit 801 extracts the facial image from the images of the user captured by the camera 401 using images of the characteristic facial feature such as eyes, nose, mouth, eyebrows and others (step S401).

Next, the posture identifying unit 801 determines “back” or “non-back” based on whether or not the facial image is extracted (step S402). More specifically, when the facial image cannot be extracted, the posture identifying unit 801 determines as “back”. On the other hand, when the facial image is successfully extracted, the posture identifying unit 801 determines as “non-back”.

Subsequently, the digital mirror apparatus 800 performs the process identical to the process described in FIG. 4 (step S103 or step S104, and step S105).

As described above, the digital mirror apparatus 800 can dynamically switch the current user image from plural viewpoints that cannot be seen using a conventional mirror between the image including the left-right reversed user image or the image including the left-right non-reversed user image, according to the posture of the user and without the operation by the user himself/herself. With this, the user can work without uncomfortable feeling, while comparing his/her movement displayed on the display unit 104.

Although only some exemplary embodiments of the digital mirror apparatus according to this invention have been described in detail above, those skilled in the art will readily appreciate that many modifications are possible in the exemplary embodiments without materially departing from the novel teachings and advantages of this invention. Accordingly, all such modifications are intended to be included within the scope of this invention

Note that, in Embodiments 1 to 4, the functional blocks of the model data generating unit, the posture identifying unit, and the image generating unit are typically implemented as the Large Scale Integration (LSI). More specifically, as shown in FIGS. 1, 6, 9 and 12, the digital mirror apparatus is typically composed of the LSIs 110, 410, 610 or 810. Furthermore, each unit of the constituent elements configuring the respective apparatuses may be made as separate individual chips or as a single chip to include a part or all thereof. Furthermore, here, System-LSI is mentioned but there are instances where, due to a difference in the degree of integration, the designations Integrated Circuit (IC), system LSI, super LSI, and ultra LSI are used. Furthermore, the means for circuit integration is not limited to an LSI and implementation with a dedicated circuit or a general-purpose processor is also available. In addition, it is also acceptable to use a Field Programmable Gate Array (FPGA) that is programmable after the LSI has been manufactured, and a reconfigurable processor in which connections and settings of circuit cells within the LSI are reconfigurable.

Furthermore, as described in the example of the body of digital mirror apparatus, the present invention can naturally be applicable to a simulation system, a game system, and a TV conference system that includes digital mirror function.

Furthermore, the present invention may be implemented as the image display method including the operations of the characteristic components of the digital mirror apparatus as steps. Furthermore, the present invention may also be implemented as a program causing a computer to execute the steps included in the image display method. Furthermore, the program may be distributed via recording media such as CD-ROM, and transmission media such as the Internet.

### INDUSTRIAL APPLICABILITY

The digital mirror apparatus according to the present invention has technology which allows a display from a predetermined angle that has been impossible to display with the conventional mirror, high visibility and operability, and is useful as home or commercial digital mirror. Furthermore, it is also useful for a system in which the user works while watching him/her reflected on the display, such as a human body exercise simulation system, a rehabilitation medical system, a game system, a Mixed Reality (MR) system, a TV conference system.

### REFERENCE SIGNS LIST

100, 400, 600, 800 Digital mirror apparatus
101 Model data storage unit
102, 403, 602, 801 Posture identifying unit
103, 404 Image generating unit
104 Display unit
110, 410, 610, 810 LSI
201 Three-dimensional model data
202 X axis
203 Y axis
204 Z axis
205 Originating point
206 Viewpoint
207, 208 Rotation angle
301, 503, 702, 1001 Display
302, 1002 Front user image
303, 1003 Back user image
304, 505, 706, 1004 User
305 Half mirror
306 Mirror image
401, 501, 701 Camera
402 Model data generating unit
450, 502 Posture sensor
504, 703, 704, 705 User image
601 Memory

1. A digital mirror apparatus for displaying an image of a user, said digital mirror apparatus comprising:
a posture identifying unit configured to determine whether or not an image to be displayed is to be an image of a back of the user, and to generate posture information indicating a result of the determination;
an image generating unit configured to generate the image to be displayed by rendering three-dimensional model data of the user; and
a display unit configured to display the image generated by said image generating unit,
wherein said image generating unit is configured to generate, as the image to be displayed, one of an image including a left-right reversed user image and an image including a left-right non-reversed user image, according to the posture information generated by said posture identifying unit.

2. The digital mirror apparatus according to claim 1,
wherein said image generating unit is configured to generate the image including the left-right non-reversed user image when the posture information generated by said posture identifying unit indicates that the image to be displayed is to be the image of the back of the user, and to generate the image including the left-right reversed user image when the posture information generated by said posture identifying unit indicates that the image to be displayed is not to be the image of the back of the user.

3. The digital mirror apparatus according to claim 1, further comprising
a model data storage unit in which the three-dimensional model data of the user is stored,
wherein said image generating unit is configured to render the three-dimensional model data stored in said model data storage unit.

4. The digital mirror apparatus according to claim 1,
wherein said posture identifying unit is configured to determine that the image to be displayed is to be the image of the back of the user when a viewpoint from which to render the three-dimensional model data is positioned in a back side of the three-dimensional model data.

5. The digital mirror apparatus according to claim 4,
wherein said posture identifying unit is configured to identify the back side of the three-dimensional model data based on an angle around an axis which is substantially perpendicular to a floor, and to determine that the image to be displayed is the image of the back of the user when the viewpoint is located on the back side of the three dimensional model data.

6. The digital mirror apparatus according to claim 1, further comprising:
a camera which captures an image the user from a plurality of directions; and
a model data generating unit configured to generate three-dimensional model data of the user from the image captured by said camera,
wherein said image generating unit is configured to render the three-dimensional model data generated by said model data generating unit.

7. The digital mirror apparatus according to claim 6,
wherein said posture identifying unit is configured to obtain sensor information indicating the posture of the user generated by a posture sensor, to identify a position and a direction of the user with respect to a display surface in said display unit using the obtained sensor information, and to determine whether or not the image to be displayed is the image of the back of the user.

8. The digital mirror apparatus according to claim 6,
wherein said posture identifying unit is configured to determine whether or not the image to be displayed is to be the image of the back of the user, based on the image captured by said camera.

9. The digital mirror apparatus according to claim 8,
wherein said posture identifying unit is configured to determine the image to be displayed is to be the image of the back of the user, when a facial image cannot be extracted from the image captured by said camera.

10. An image display method for displaying an image of a user, said method comprising:
determining whether or not an image to be displayed is to be an image of a back of the user to generate posture information indicating a result of the determination;
generating the image to be displayed by rendering three-dimensional model data of the user; and
displaying the image generated in said generating,
wherein in said generation of the image, one of an image including a left-right reversed user image and an image including a left-right non-reversed user image is generated as the image to be displayed, according to the posture information generated in said identifying.

11. An integrated circuit for generating an image of a user, which is an image to be displayed on a display unit, said integrated circuit comprising:
a posture identifying unit configured to determine whether or not the image to be displayed is to be an image of a back of the user and to generate posture information indicating a result of the determination;
an image generating unit configured to generate the image to be displayed by rendering three-dimensional model data of the user; and
wherein said image generating unit is configured to generate, as the image to be displayed, one of an image including a left-right reversed user image and an image including a left-right non-reversed user image, according to the posture information generated by said posture identifying unit.

12. A program product for displaying an image of a user, which, when loaded into a computer, allows the computer to execute:
determining whether or not an image to be displayed is to be an image of a back of the user to generate posture information indicating a result of the determination;
generating the image to be displayed by rendering three-dimensional model data of the user; and
displaying the image generated in said generating,
wherein in said generation of the image, one of an image including a left-right reversed user image and an image including a left-right non-reversed user image is generated as the image to be displayed, according to the posture information generated in said identifying.
